(19) United States
(12) Patent Application Publication
(10) Pub. No.: US 2026/0089645 A1
(43) Pub. Date: Mar. 26, 2026

(54) TRANSMISSION POWER CONTROL TECHNIQUES FOR SCHEDULING REQUESTS

(71) Applicant: QUALCOMM Incorporated, San Diego, CA (US)

(72) Inventors: Linhai HE, San Diego, CA (US); Yi HUANG, San Diego, CA (US)

(21) Appl. No.: 19/234,139

(22) Filed: Jun. 10, 2025

Related U.S. Application Data
(60) Provisional application No. 63/698,485, filed on Sep. 24, 2024.

(51) Int. Cl. H04W 52/14; H04W 72/1268

(52) U.S. Cl. CPC H04W 52/146; H04W 72/1268

(57) ABSTRACT

Methods, systems, and devices for wireless communications are described. A user equipment (UE) may use an uplink transmission power for transmitting a scheduling request (SR) that is based on whether a transmit power control (TPC) timer has expired. For example, after receiving a TPC command, the UE may start the TPC timer. In cases where the TPC timer is running when the UE transmits the SR, the UE may calculate the uplink transmission power in accordance with a first technique. Alternatively, if the TPC timer expires prior to transmission of the SR, the UE may determine the uplink transmission power in accordance with a second technique associated with power ramping of the uplink transmission power. In such cases, the UE may use an initial uplink transmission power for an initial SR transmission, and the UE may increment a power offset for the uplink transmission power for retransmissions of the SR.

### CROSS REFERENCE

The present Application for Patent claims the benefit of U.S. Provisional Patent Application No. 63/698,485 by H E et al., entitled “TRANSMISSION POWER CONTROL TECHNIQUES FOR SCHEDULING REQUESTS,” filed Sep. 24, 2024, assigned to the assignee hereof, and which is expressly incorporated by reference herein.

### FIELD OF TECHNOLOGY

The following relates to wireless communications, including transmission power control techniques for scheduling requests.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by an apparatus is described. The method may include receiving a control message including a transmit power control (TPC) command for one or more uplink transmissions, starting a TPC timer in response to receiving the TPC command, and transmitting one or more scheduling requests via a PUCCH (PUCCH), where an uplink transmission power for the one or more scheduling requests is based on whether the TPC timer has expired.

An apparatus for wireless communications is described. The apparatus may include one or more memories storing processor executable code, and one or more processors coupled with the one or more memories. The one or more processors may individually or collectively be operable to execute the code to cause the apparatus to receive a control message including a TPC command for one or more uplink transmissions, start a TPC timer in response to receiving the TPC command, and transmit one or more scheduling requests via a PUCCH, where an uplink transmission power for the one or more scheduling requests is based on whether the TPC timer has expired.

Another apparatus for wireless communications is described. The apparatus may include means for receiving a control message including a TPC command for one or more uplink transmissions, means for starting a TPC timer in response to receiving the TPC command, and means for transmitting one or more scheduling requests via a PUCCH, where an uplink transmission power for the one or more scheduling requests is based on whether the TPC timer has expired.

A non-transitory computer-readable medium storing code for wireless communications is described. The code may include instructions executable by one or more processors to receive a control message including a TPC command for one or more uplink transmissions, start a TPC timer in response to receiving the TPC command, and transmit one or more scheduling requests via a PUCCH, where an uplink transmission power for the one or more scheduling requests is based on whether the TPC timer has expired.

In some examples of the method, apparatus, and non-transitory computer-readable medium described herein, the one or more scheduling requests may be transmitted prior to an expiration of the TPC timer and the method, apparatuses, and non-transitory computer-readable medium may include further operations, features, means, or instructions for calculating the uplink transmission power for the one or more scheduling requests based on the TPC timer running, where the calculated uplink transmission power may be based on a power control parameter, a bandwidth of the PUCCH, a path loss estimate, a PUCCH offset parameter, a PUCCH power adjustment parameter, a power control adjustment state indicated by the TPC command, a threshold transmit power, or any combination thereof.

In some examples of the method, apparatus, and non-transitory computer-readable medium described herein, the one or more scheduling requests may be transmitted after an expiration of the TPC timer and the method, apparatuses, and non-transitory computer-readable medium may include further operations, features, means, or instructions for determining a first uplink transmission power for a first scheduling request of the one or more scheduling requests based on the expiration of the TPC timer, where the first scheduling request may be transmitted using the first uplink transmission power.

Some examples of the method, apparatus, and non-transitory computer-readable medium described herein may further include operations, features, means, or instructions for transmitting, based on the first scheduling request being unsuccessful, a second scheduling request of the one or more scheduling requests after transmitting the first scheduling request, where the second scheduling request may be transmitted using a second uplink transmission power that may be greater than the first uplink transmission power by a power offset value.

Some examples of the method, apparatus, and non-transitory computer-readable medium described herein may further include operations, features, means, or instructions for receiving a message indicating a set of power offset values, where the power offset value may be from the set of power offset values.

In some examples of the method, apparatus, and non-transitory computer-readable medium described herein, each power offset value of the set of power offset values corresponds to a respective trigger type associated with the one or more scheduling requests.

Some examples of the method, apparatus, and non-transitory computer-readable medium described herein may further include operations, features, means, or instructions for incrementing the power offset value for respective scheduling requests of the one or more scheduling requests that may be transmitted after the second scheduling request, where the power offset value may be incremented until the uplink transmission power satisfies a threshold uplink transmission power or until a second uplink power control command may be received.

Some examples of the method, apparatus, and non-transitory computer-readable medium described herein may further include operations, features, means, or instructions for receiving a second control message including an indication of a set of uplink transmission powers that includes at least the first uplink transmission power, where determining the first uplink transmission power may be based on receiving the second control message.

In some examples of the method, apparatus, and non-transitory computer-readable medium described herein, each uplink transmission power of the set of uplink transmission powers corresponds to respective trigger type for transmitting the one or more scheduling requests.

Some examples of the method, apparatus, and non-transitory computer-readable medium described herein may further include operations, features, means, or instructions for receiving a third control message including an indication of a range of uplink transmission powers that includes at least the first uplink transmission power and selecting the first uplink transmission power from the range of uplink transmission powers based on one or more transmission power parameters associated with prior transmissions, where the first uplink transmission power may be determined in accordance with the selection.

In some examples of the method, apparatus, and non-transitory computer-readable medium described herein, the one or more transmission power parameters include one or more uplink transmission powers associated with successful scheduling requests, one or more path loss measurements associated with the successful scheduling requests, or any combination thereof.

Some examples of the method, apparatus, and non-transitory computer-readable medium described herein may further include operations, features, means, or instructions for selecting the first uplink transmission power based on an output of one or more machine learning models, where the one or more machine learning models use a set of parameters associated with a set of prior transmissions.

In some examples of the method, apparatus, and non-transitory computer-readable medium described herein, transmitting the one or more scheduling requests may include operations, features, means, or instructions for transmitting a group of consecutive scheduling requests in accordance with a set of transmission occasions and starting a prohibit timer after transmitting the group of consecutive scheduling requests.

Some examples of the method, apparatus, and non-transitory computer-readable medium described herein may further include operations, features, means, or instructions for receiving a fourth control message indicating a quantity of scheduling requests included in the group of consecutive scheduling requests, where transmitting the group of consecutive scheduling requests may be based on the fourth control message.

Some examples of the method, apparatus, and non-transitory computer-readable medium described herein may further include operations, features, means, or instructions for applying respective uplink transmission powers to each scheduling request of the group of consecutive scheduling requests based on whether the TPC timer may have expired.

Some examples of the method, apparatus, and non-transitory computer-readable medium described herein may further include operations, features, means, or instructions for applying a fourth uplink transmission power for each scheduling request of the group of consecutive scheduling requests, where an additional group of consecutive scheduling requests transmitted after the group of consecutive scheduling requests uses a fifth uplink transmission power that may be greater than the fourth uplink transmission power.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports transmission power control techniques for scheduling requests in accordance with one or more aspects of the present disclosure.

FIG. 2 shows an example of a wireless communications system that supports transmission power control techniques for scheduling requests in accordance with one or more aspects of the present disclosure.

FIG. 3 shows an example of a transmission timeline that supports transmission power control techniques for scheduling requests in accordance with one or more aspects of the present disclosure.

FIG. 4 shows an example of a process flow that supports transmission power control techniques for scheduling requests in accordance with one or more aspects of the present disclosure.

FIGS. 5 and 6 show block diagrams of devices that support transmission power control techniques for scheduling requests in accordance with one or more aspects of the present disclosure.

FIG. 7 shows a block diagram of a communications manager that supports transmission power control techniques for scheduling requests in accordance with one or more aspects of the present disclosure.

FIG. 8 shows a diagram of a system including a device that supports transmission power control techniques for scheduling requests in accordance with one or more aspects of the present disclosure.

FIGS. 9 through 11 show flowcharts illustrating methods that support transmission power control techniques for scheduling requests in accordance with one or more aspects of the present disclosure.

### DETAILED DESCRIPTION

In some wireless communications, a user equipment (UE) may provide an indication to another device (e.g., a network entity) when the UE has data available to send, which may be referred to as a scheduling request (SR). As an example, the UE may transmit an SR via a physical uplink control channel (PUCCH) when the UE has data available to transmit but no uplink resources have been allocated to the UE (e.g., the UE has not received a resource grant for one or more data transmissions). After receiving the SR from the UE, a network entity may respond with an uplink grant allocating time/frequency resources for the data transmission. In cases where the UE does not receive the uplink grant in response to the initial SR transmission, the UE may retransmit the SR one or more times (e.g., up to a configured threshold).

When transmitting one or more SRs via PUCCH, the UE may calculate a corresponding transmission power in accordance with a formula that includes one or more values configured by the network, a PUCCH bandwidth, an estimated path loss, a value associated with a PUCCH format, and/or a value corresponding to a transmit power control (TPC) command. Here, the TPC command may correspond to a mechanism by which a transmit power is adjusted (e.g., increased, decreased, maintained) in an attempt to obtain a transmission power that enables reception of signals, while minimizing interference to other devices.

SR transmissions, however, may sometimes fail due to an inaccurate or insufficient transmission power used by the UE. As an example, after relatively long periods of data inactivity by a UE (such as when the UE is in a discontinuous reception (DRX) or other power-saving mode), a most recent TPC command may not be available to the UE or may not provide sufficient power adjustment for a current uplink transmission. Similarly, the UE may be mobile and change locations within a cell during a period of data inactivity, and a transmit power based on previously-used parameters may not be suitable for an SR sent in the UE's current location. Thus, in the absence of techniques enabling dynamic power adaptation for SR transmissions, the UE may repeatedly transmit SR with a same power (e.g., that is based on outdated or inaccurate information) until a failure is triggered, resulting in inefficiencies and delayed communications, among other issues.

The described techniques enable dynamic SR transmission power calculations based on when a most-recent TPC command was received. In particular, a TPC timer may be started after the UE receives a TPC command and, while the TPC timer is running, a UE may calculate a transmission power for the SR in accordance with one or more power control procedures. In cases where the TPC timer expires prior to an SR transmission, the UE may apply power ramping for each SR transmission of one or more SR transmissions, which may promote the reception of the SR by using a relatively increased power (e.g., as compared to conventional techniques). More specifically, the UE may use a configured uplink transmission power for an initial transmission of the SR (e.g., after the TPC timer expires), and the UE may thereafter increment the transmission power by some offset for each retransmission of the SR (e.g., up to a threshold transmission power or until a TPC command is received).

In some aspects, the initial SR transmission power may be configured by the network, or the UE may select the initial SR transmission power based on one or more parameters (e.g., using one or more artificial intelligence (AI)/machine learning (ML) models/functionalities). In some implementations, the UE may transmit a burst or set of SRs before starting a prohibit timer, which may similarly enable the successful reception of the SR by the network (e.g., by increasing the chances of a successful SR reception). Here, the set of SRs may be transmitted in consecutive PUCCH transmission occasions and the quantity of SR transmissions in a set may, for example, be configured by the network.

Aspects of the disclosure are initially described in the context of wireless communications systems. Aspects of the disclosure are additionally described with reference to a process flow. Aspects of the disclosure are further illustrated by and described with reference to apparatus diagrams, system diagrams, and flowcharts that relate to transmission power control techniques for scheduling requests.

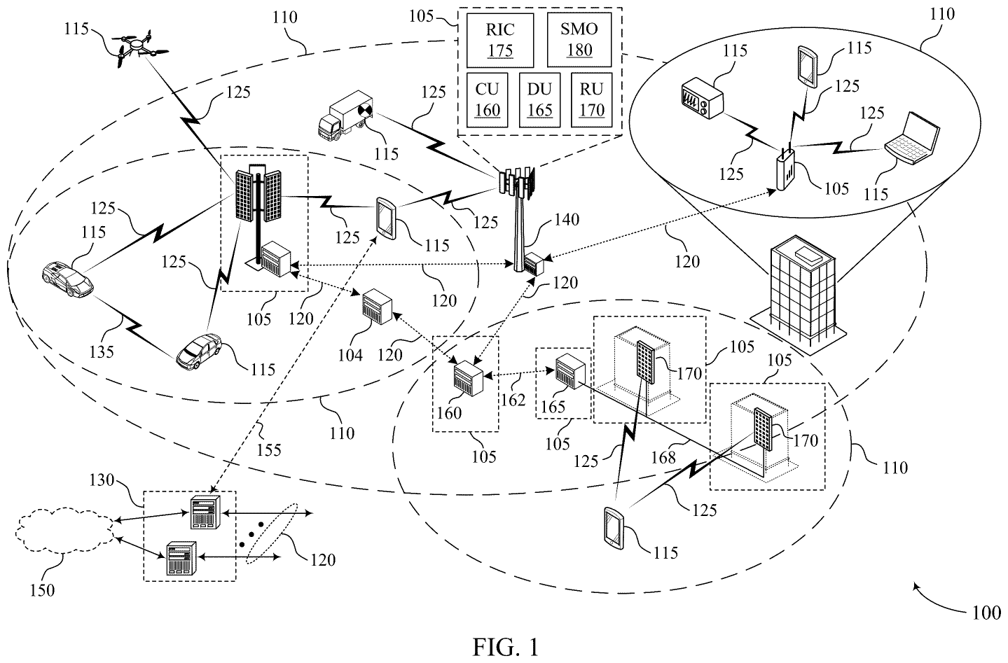

FIG. 1 shows an example of a wireless communications system 100 that supports transmission power control techniques for scheduling requests in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support transmission power control techniques for scheduling requests as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

In some examples, a UE 115 may support AI and/or ML models and/or functionalities, which the UE 115 may use to perform various wireless communications procedures (e.g., CSI prediction, beam selection, and/or beam prediction, among other examples). In such cases, the UE 115 may generate inference data using one or more AI/ML models/functionalities. Additionally, or alternatively, the UE 115 may perform life cycle management (LCM) operations for a given AI/ML model and/or functionality (e.g., model or functionality selection, activation, deactivation, switching, and fallback, among other examples) based on one or more AI/ML models/functionalities. In some aspects, LCM may be model-based or functionality-based LCM procedures. In some examples, a UE 115 may use an AI/ML model and/or functionality to analyze one or more parameters associated with past transmissions to make decisions about current or future transmissions, such as determining a transmission power.

As described herein, an AI functionality or AI model may be referred to as an ML functionality or ML model, or vice versa. That is, the terms “AI” and “ML” may, in some examples, be used interchangeably to refer to similar technologies, models, functions, algorithms, or any combination thereof. Similarly, the terms “model” and “functionality” may be used interchangeably. In some examples, ML operations may be considered a subset of AI operations. In any case, aspects of the features described herein may be referred to as AI functionalities, AI functions, AI models, AI services, AI operations, or the like, and such features may be similarly applicable to ML functionalities, ML functions, ML models, ML services, ML operations, or any combination thereof. Thus, reference to “ML” or “AI” may refer to ML, AI, or both, and the terms “AI” or “ML” should not be considered limiting to the scope of the claims or the disclosure.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example, a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may support techniques that enable increased uplink power control for uplink transmissions, such as scheduling requests. For instance, a UE 115 may use an uplink transmission power (e.g., for transmitting SR) that is based on whether a TPC timer has expired. In particular, after receiving a TPC command, the UE 115 may start the TPC timer. In cases where the TPC timer is still running when the UE 115 has data to send to a network entity 105 and transmits the SR, the UE 115 may calculate the uplink transmission power in accordance with a first technique. Alternatively, if the TPC timer has expired prior to transmitting the SR, the UE 115 may determine the uplink transmission power in accordance with a second technique associated with power ramping of the uplink transmission power. Here, the UE may be configured with an initial uplink transmission power and a power offset value to use for cases when SR is transmitted after the expiration of the TPC timer. As such, the UE 115 may use the initial uplink transmission power for an initial SR transmission, and the UE 115 may increment the power offset value for the uplink transmission power corresponding to retransmissions of the SR (e.g., up to a threshold transmission power or until another TPC command is received). In some aspects, the UE 115 may determine the initial uplink transmission power based on one or more parameters and/or an output of one or more AI/ML models/functionalities. In any case, the TPC timer may enable the UE 115 to determine whether a TPC command is no longer relevant (e.g., outdated, “stale”) to a current uplink transmission power calculation, further enabling the UE 115 to use improved power control techniques to help ensure that the SR is received by a network entity 105.

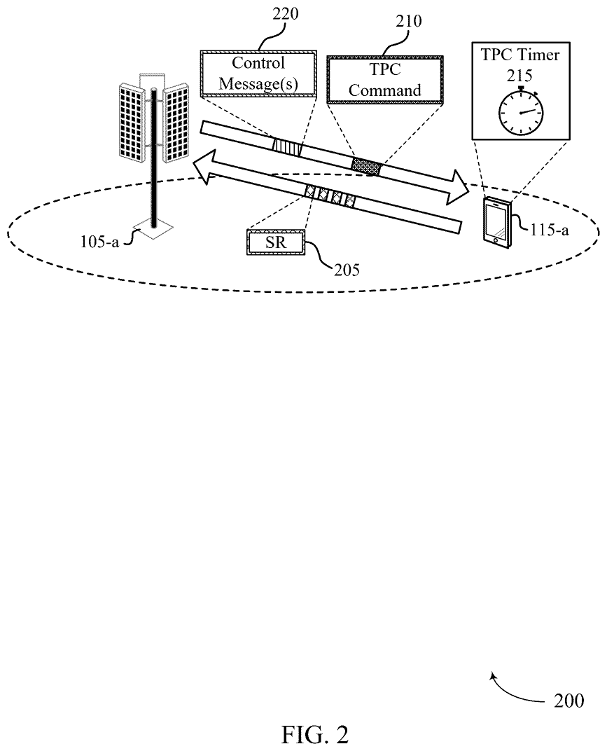

FIG. 2 shows an example of a wireless communications system 200 that supports transmission power control techniques for scheduling requests in accordance with one or more aspects of the present disclosure. The wireless communications system 200 may implement aspects of or may be implemented by aspects of the wireless communications system 100. For example, the wireless communications system 200 includes a UE 115-a and a network entity 105-a, which may be examples of a UE 115 and a network entity 105 described with respect to FIG. 1. In some examples, the wireless communications system 200 may support techniques for ramping an uplink transmission power for transmitting one or more uplink signals, such as an SR. An uplink transmission power may be similarly referred to as an uplink transmit power or some similar terminology.

When the UE 115-a has new data that is available for transmission, the UE 115-a may transmit an SR 205 via a PUCCH to indicate, to the network entity 105-a, that the UE 115-a is requesting an uplink grant. In such cases, a buffer status report (BSR) may be triggered based on the availability of the data, where the BSR may indicate information about a quantity of uplink data for transmission by the UE 115-a (e.g., to the network entity 105-a). After receiving the SR 205 from the UE 115-a, the network entity 105-a may respond with control information providing an uplink grant allocating time/frequency resources to the UE 115-a for one or more uplink data transmission.

In cases where the UE 115-a does not receive the uplink grant in response to a transmission of the SR 205, the UE may retransmit the SR 205 one or more times (e.g., up to a configured threshold). For example, the UE 115-a may be configured with a threshold (e.g., maximum) quantity of SR transmissions via one or more control messages (e.g., RRC signaling indicating a parameter sr-TransMax). Thus, in cases where the UE 115-a has not received an uplink grant from network entity 105-a, the UE 115-a repeats the SR 205 until a quantity of transmissions of the SR 205 reaches the configured threshold. In some cases, the SR 205 may be transmitted via uplink control information (UCI) and included in the PUCCH, where the UCI may include the SR 205, HARQ-ACK information, a link recovery request (LRR), channel state information (CSI), or any combination thereof.

When transmitting one or more SRs 205, the UE 115-a may calculate an uplink transmission power (e.g., a power for transmitting PUCCH) in accordance with a formula that includes one or more values configured by the network, a PUCCH bandwidth, an estimated path loss, a value associated with a PUCCH format, and/or a value corresponding to a TPC command. In particular, the UE 115-a may calculate the uplink transmission power (e.g., in decibel milliwatts (dBm)) in accordance with Equation 1:

$${P}_{PUCCH , b , f , c} ( i , {q}_{u} , {q}_{d} , l ) = min \{ \begin{matrix}{P}_{CMAX , f , c} ( i ) \\ A + B + C + D + E + F\end{matrix} \qquad ( 1 )$$

$$where :$$

$$A = {P}_{O \_ PUCCH , b , f , c} ( {q}_{u} )$$

$$B = 10 {log}_{10} ( {2}^{μ} \cdot {M}_{RB , b , f , c}^{PUCCH} ( i ) )$$

$$C = {PL}_{b , f , c} ( {q}_{d} )$$

$$D = {Δ}_{F \_ PUCCH} ( F )$$

$$E = {Δ}_{TF , b , f , c} ( i )$$

$$F = {g}_{b , f , c} ( i , l )$$

Here, P_{CMAX,f,c}(i) is a configured threshold (e.g., maximum) output power (e.g., a threshold transmit power for the UE 115-a) for a carrier f of a serving cell c in a PUCCH transmission occasion i, b is an uplink bandwidth part (BWP) of the carrier f in the cell c, and l is a power control adjustment state index. Further, P_{O_PUCCH,b,f,c}(qᵤ) is a power control parameter including a sum of components configured by the network (e.g., via higher-layer signaling) for the BWP b of the carrier f of the cell c, qᵤ is a size for a set of power control parameter values, μ is a numerology corresponding to a subcarrier spacing,

$${M}_{RB , b , f , c}^{PUCCH} ( i )$$

is a bandwidth of a PUCCH resource assignment expressed in a quantity of resource blocks (RBs) for PUCCH transmission occasion i on the BWP b of carrier f of cell c, and PL_{b,f,c}(q_{d}) is a downlink pathloss estimate (e.g., in dB) calculated by the UE 115-a using RS resource index q_{d}. Additionally, Δ_{F_PUCCH}(F) is a value corresponding to a PUCCH format (e.g., provided via higher-layer signaling for some PUCCH formats, 0 otherwise), Δ_{TE,b,f,c}(i) is a PUCCH transmission power adjustment component on an active BWP b of carrier f of primary cell c, and g_{b,f,c}(i, l) is a PUCCH power control adjustment state l (e.g., indicated by a TPC command 210) for BWP b of carrier f of primary cell c and PUCCH transmission occasion i.

Thus, in Equation 1, P_{O_PUCCH,b,f,c}(qᵤ) may correspond to a value configured by the network entity 105-a,

$${M}_{RB , b , f , c}^{PUCCH} ( i )$$

may corresponding to a PUCCH bandwidth, PL_{b,f,c}(q_{d}) may correspond to a pathloss estimate, Δ_{F_PUCCH} (F) may correspond to a physical uplink control channel offset parameter, Δ_{TF,b,f,c}(i) may correspond to a physical uplink control channel power adjustment parameter, and g_{b,f,c}(i, l) may correspond to a power control adjustment state indicated by the TPC command 210 and provided to the UE 115-a.

In some examples, the TPC command 210 may correspond to a mechanism by which a transmit power is adjusted (e.g., increased, decreased, maintained) to obtain a transmission power that enables reception of signals, while minimizing interference to other devices in the wireless communications system 200. In some cases, the TPC command 210 may be signaled to the UE 115-a via a control message, such as downlink control information (DCI).

The transmission of the SR 205, however, may fail (e.g., fail frequently) due to an inaccurate or insufficient transmission power used by the UE 115-a. As an example, after relatively long periods of data inactivity by the UE 115-a (such as when the UE 115-a is in a DRX mode or other power-saving mode), a relatively more recent TPC command 210 may not be available to the UE 115-a, or a previously-received TPC command 210 may not provide sufficient power adjustment for a current uplink transmission. In such cases, an accurate TPC command 210 or other transmission power parameters may not be available to the UE 115-a when the SR 205 is transmitted, for example, during a DRX off period, potentially resulting in SR failure due to an insufficient uplink transmission power. In some examples, the UE 115-a may be mobile within a cell provided by the network entity 105-a and/or the UE 115-a may change locations within the cell during a period of data inactivity. In such cases, a configured value for a power control parameter (e.g., P_{O_PUCCH,b,f,c}(qᵤ)) may not provide a sufficient power for an SR transmission, for example, due to an increased interference level experienced by the UE 115-a. As such, a transmission power used by the UE 115-a that is based on previously-used parameters (such as a relatively old TPC command 210 or other parameters) may not be suitable for an SR 205 sent in a current location and/or state of the UE 115-a.

In cases where SR transmissions are unsuccessful, the UE 115-a may repeat transmissions of the SR 205 with a same power until a failure is triggered (e.g., when a threshold quantity of transmissions is reached), which may result in a reset of uplink resources for the UE 115-a, and may further lead to random access procedures being performed by the UE 115-a to re-establish an active connection with the network entity 105-a. SR failure may accordingly lead to numerous issues, including decreased communications efficiency, latency, and reduced service, among others. Thus, in the absence of techniques enabling dynamic power adaptation for SR transmissions (e.g., power ramping techniques), the UE 115-a may repeatedly transmit SR with a same power (e.g., that is based on outdated or inaccurate information) until a failure occurs, resulting in various inefficiencies and delayed communications, among other issues.

The wireless communications system 200 may support enhanced techniques for dynamic transmission power calculation based on when a most-recent TPC command 210 was received. For instance, the UE 115-a may implement a TPC timer 215 that is started and/or re-started when the UE 115-a receives a TPC command 210. The UE 115-a may determine an uplink transmission power (e.g., for an SR transmission via PUCCH) based on whether the TPC timer 215 is running. As an example, when one or more SRs 205 are to be transmitted prior to an expiration of the TPC timer 215 (e.g., while the TPC timer 215 is running), the UE 115-a may calculate the transmission power for the one or more SR transmission in accordance with a first technique (e.g., using Equation 1). Here, the active TPC timer 215 running before expiration may indicate that the TPC command 210 was recently received by the UE 115-a, and any uplink transmission power calculation based on that TPC command 210 may provide a sufficient uplink transmission power for transmitting the SR(s) 205 (e.g., dynamic power adjustment may not be needed).

Alternatively, such as in cases where the one or more SRs 205 are to be transmitted after the TPC timer 215 has expired (e.g., when the TPC timer 215 is not running), the UE 115-a may apply power ramping for each SR transmission of one or more SR retransmissions, which may promote the reception of the one or more SRs 205 by using a relatively increased power (e.g., as compared to conventional techniques). In such cases, the expiration of the TPC timer 215 may indicate that the TPC command 210 is relatively old or possibly outdated, and some dynamic power adjustment may be needed. For example, if the TPC timer 215 has expired (e.g., while the UE 115-a is in a power-saving mode, such as DRX, or for other reasons) and the UE 115-a is to transmit an SR 205, the UE 115-a may determine an uplink transmission power for the SR 205 using a transmission power value, which may be denoted as Pᵢ that corresponds to the ith SR transmission. Here, an initial value of Pᵢ (e.g., for a first SR transmission, an initial SR transmission) may be P₀. Further, the uplink transmission power for subsequent transmissions of the SR 205 (e.g., SR retransmissions) may be determined using Pᵢ=Pᵢ₋₁+δ, where δ may be a power offset value that is configured by the network entity 105-a. As an example, the network entity 105-a may transmit one or more control messages 220 that indicate the power offset value, δ, where respective values of the power offset may correspond to different SR triggers. For instance, a relatively high-priority SR transmission/trigger may be associated with a first power offset value, δ₁, that has a relatively larger value than a second power offset value, δ₂, associated with another SR trigger. In another example, an SR transmission triggered by a beam failure (e.g., corresponding to a beam failure recovery (BFR) procedure) may have a different power offset value. Other examples of SR triggers and power offset values may be possible, and the examples described herein should not be considered limiting to the scope of the claims or the disclosure. In any case, a relatively larger value of the power offset, which may be incremented for subsequent retransmissions of the SR 205, may enable the UE 115-a to reach a threshold transmission power sooner, thereby improving the chances of the SR being successful relatively more quickly (and possibly before the threshold transmission power is reached).

Thus, in examples where an initial transmission of the SR 205 is unsuccessful, the UE 115-a may increase (e.g., increment) the uplink transmission power by the power offset value, δ, for each retransmission of the SR 205 (e.g., for each subsequent transmission of the SR 205). The uplink transmission power may be incremented (e.g., by incrementing the power offset value δ) until the threshold transmit power (e.g., P_{CMAX,f,c}(i)) is reached. Additionally, or alternatively, the uplink transmission power may be incremented (e.g., by incrementing the power offset value δ) until another TPC command 210 is received by the UE 115-a. Subsequent transmissions of the SR 205 may accordingly be associated with incrementally increased power (e.g., up to a threshold) to provide higher likelihood that the SR 205 will be received by the network entity 105-a. Such power adaptation techniques may enable improved communications efficiency by reducing the occurrence of SR failure. In some aspects, the UE 115-a may stop transmission/re-transmission of the SR 205 after reaching the threshold (e.g., maximum) quantity of SR transmissions (e.g., corresponding to sr-TransMax).

In some aspects, the initial SR transmission power, P₀, may be configured by the network entity 105-a. As an example, the network entity 105-a may configure, via one or more control messages 220, different values of P₀ for different SR triggers. The UE 115-a may select the initial value, P₀, for a first transmission of the SR 205 from a set of power values indicated by the network entity 105-a, and the UE 115-a may determine the corresponding uplink transmission power for the SR 205 based on the selected value of P₀. In some examples, the control message 220 may indicate a range of values for P₀, where the range includes a minimum value (e.g., Pₘᵢₙ) and a maximum value (e.g., Pmax).

The UE 115-a may select the initial SR transmission power, P₀, which may be configured for the UE 115-a (e.g., via the control message 220) or determined by the UE 115-a, for example, based on one or more parameters (e.g., using one or more AI/ML models/functionalities). For example, P₀ may be selected based on one or more uplink transmission power levels recently used by the UE 115-a. In some cases, the one or more parameters may include a first parameter, Pₛ, which may be a power level at which an SR transmission was successful (e.g., where a successful SR is an SR transmission after which the UE 115-a received an uplink grant). The one or more parameters may further include a second parameter, PLₛ, which may be the last path loss measurement obtained by the UE 115-a prior to a successful SR transmission. In some examples, the transmission power based on P₀ may be selected based on a regression of the first parameter and the second parameter (e.g., a regression of Pₛ+PLₛ), less a current path loss measurement. In some aspects, one or more other parameters may be used for selecting the value of P₀.

Therefore, the power adjustment techniques described herein may provide the UE 115-a with additional flexibility in determining an uplink transmission power for transmitting one or more SRs 205, thereby enhancing the likelihood of a successful SR transmission and corresponding reception of an uplink grant. Such techniques may according enhance communication efficiency and resource usage within the wireless communications system 200.

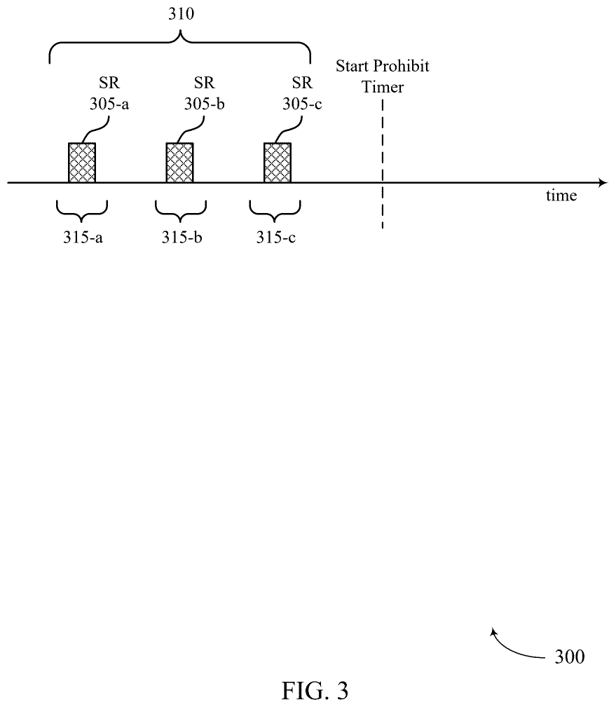

FIG. 3 shows an example of a transmission timeline 300 that supports transmission power control techniques for scheduling requests in accordance with one or more aspects of the present disclosure. The transmission timeline 300 may implement aspects of or may be implemented by aspects of the wireless communications system 100 and the wireless communications system 200. For example, the transmission timeline may correspond to transmission of one or more SRs 305 by a UE 115, which may be an example of a UE 115 or a UE 115-a described with respect to FIG. 1 and FIG. 2, respectively. In some examples, the transmission timeline 300 may support techniques for ramping an uplink transmission power for transmitting one or more uplink signals, such as an SR.

In some cases, SR transmission may be subject to a prohibit timer. The prohibit timer may be started when the UE transmits an SR 305. While the prohibit timer is running, the UE may not be allowed to transmit another SR 305 (e.g., the UE may be prohibited from transmitting one or more additional SRs 305).

In some aspects, the UE may transmit a group of SRs 310 (which may be referred to as an SR burst, a set of SRs, or some other terminology) before starting a prohibit timer. As an example, the group of SRs 310 may include a quantity of SR transmissions, including a first SR 305-a, a second SR 305-b, a third SR 305-c, and so forth. Each SR 305 in the group of SRs 310 may be transmitted in consecutive PUCCH occasions 315 before the UE starts the prohibit timer. That is, the first SR 305-a may be transmitted within a first PUCCH occasion 315-a, the second SR 305-b may be transmitted within a second PUCCH occasion 315-b, the third SR 305-c may be transmitted within a third PUCCH occasion 315-c, and so on. The use of the group of SRs 310 may enhance the chances of a successful reception of the SR 305 by a network entity.

In some examples, a quantity of SR transmissions within the group of SRs 310 may be configured, for example, by a network entity. In some aspects, a quantity of SRs transmission, S, in the group of SRs 310 may be based on a priority of one or more SR triggers. For example, for relatively higher priority SR triggers, there could be relatively more SR transmissions included in the group of SRs 310 (e.g., a greater value of S), whereas for relatively lower priority SR triggers (e.g., relatively less urgent SR transmissions), there may be a fewer quantity of SR transmissions including in the group of SRs 310 (e.g., a smaller value of S). The quantity of SR transmissions in the group of SRs 310 may be based on one or more other factors or parameters, such as a quantity of other devices in a cell, or whether one or more other devices are present in the cell, or the like.

When transmitting the group of SRs 310, the UE may apply one or more power ramping procedures (e.g., for dynamic power adjustment) for respective SR transmissions within the group of SRs 310 (such as described with reference to FIG. 2). In such cases, a power offset value may be incremented for respective SR transmissions within the group of SRs 310. Additionally, or alternatively, the UE may apply a same transmission power to each of the transmissions of the SR 305 within the group of SRs 310. In some aspects, the UE may increase the uplink transmission power when a subsequent group of SRs 310 begins, thereby enabling additional techniques for dynamic power scaling for SR transmissions. In some cases, the UE may receive one or more control messages that configures how the UE applies power scaling to the group of SRs 310 (or to respective SRs 305 within the group of SRs 310).

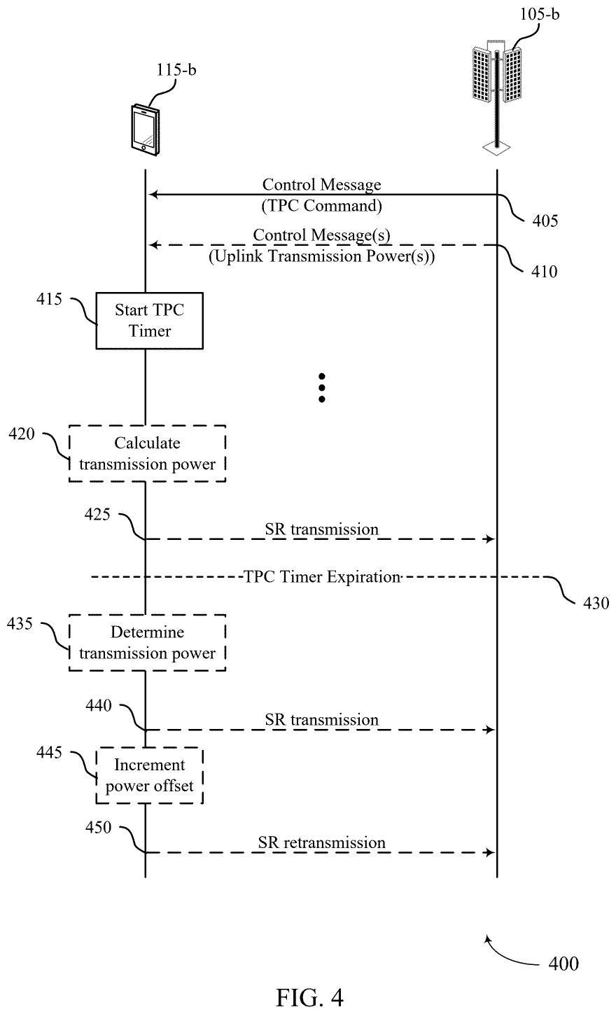

FIG. 4 shows an example of a process flow 400 that supports transmission power control techniques for scheduling requests in accordance with one or more aspects of the present disclosure. The process flow 400 may implement or be implemented to realize aspects of the wireless communications system 100, the wireless communications system 200, and/or the transmission timeline 300, described with reference to FIGS. 1, 2, and 3, respectively. The process flow 400 may include a UE 115-b and a network entity 105-b, which may be example of the corresponding devices described with reference to FIGS. 1 and 2.

Alternative examples of the following may be implemented. Some steps are performed in a different order than described or are not performed at all. In some implementations, steps may include additional features not mentioned below, or further steps may be added. Further, although the UE 115-b and network entity 105-b are shown performing the operations of the process flow 400, some aspects of some operations may also be performed by one or more other wireless communication devices.

At 405, the network entity 105-a may transmit, and the UE 115-b may receive, a control message including a TPC command for one or more uplink transmissions. In some examples, the control message may be an example of DCI received by the UE 115-b.

At 410, the UE may optionally receive, from the network entity 105-b, one or more control messages that include an indication of uplink transmission parameters. For example, a control message received at 410 may include a set of set of power offset values. Additionally, or alternatively, a control message received at 410 may include a set of uplink transmission powers, for example, that correspond to an initial uplink transmission power. In particular, the control message may indicate one or more values of P₀, such as described with reference to FIG. 2, which the UE 115-b may use for an initial SR transmission. Additionally, or alternatively, a control message received at 410 may include a range of transmission powers, from which an uplink transmission power is selected by the UE 115-b for one or more transmissions of an SR.

At 415, the UE 115-b may start a TPC timer in response to receiving the TPC command (e.g., at 405). In some examples, a duration of the TPC timer may be fixed or may be configurable (e.g., by the UE 115-b, by the network entity 105-b). Whether the TPC timer is running may have an impact on how an uplink transmission power is calculated.

For example, at 420, the UE 115-b may calculate the uplink transmission power based on one or more SR transmissions occurring prior to an expiration of the TPC timer. In such cases, the UE 115-b may use a first technique for calculating the uplink transmission power, which may, for example, include the use of Equation 1 described with reference to FIG. 2. In such cases, at 425, the UE 115-b may transmit the one or more SRs via a PUCCH based on the calculated uplink transmission power.

Alternatively, at 430, the TPC timer may expire, and at 435 the UE 115-b may determine the uplink transmission power based on the one or more SRs being transmitted after the expiration of the TPC timer. In such cases, the UE 115-b may select an initial transmission power value, which may be configured by the network entity 105-b, for determining a first uplink transmission power for an initial SR transmission the one or more SR transmissions. At 440, the UE 115-b may transmit the initial SR using the determined first uplink transmission power.

In some cases, the initial SR transmission may be unsuccessful, and the UE 115-b may increase the uplink transmission power used for retransmissions of the SR using dynamic power adjustment techniques described herein. For example, at 445, the UE 115-b may increment a power offset value and may determine the uplink transmission power based on the previously-used uplink transmission power (e.g., for the SR transmission at 440) and the power offset value. In such cases, the UE 115-b may determine a second uplink transmissions power for the SR retransmission at 450, where the second uplink transmissions power may be greater than the first uplink transmissions power based on the power offset value.

At 450, the UE 115-b may transmit the SR retransmission using the relatively increased uplink transmission power.

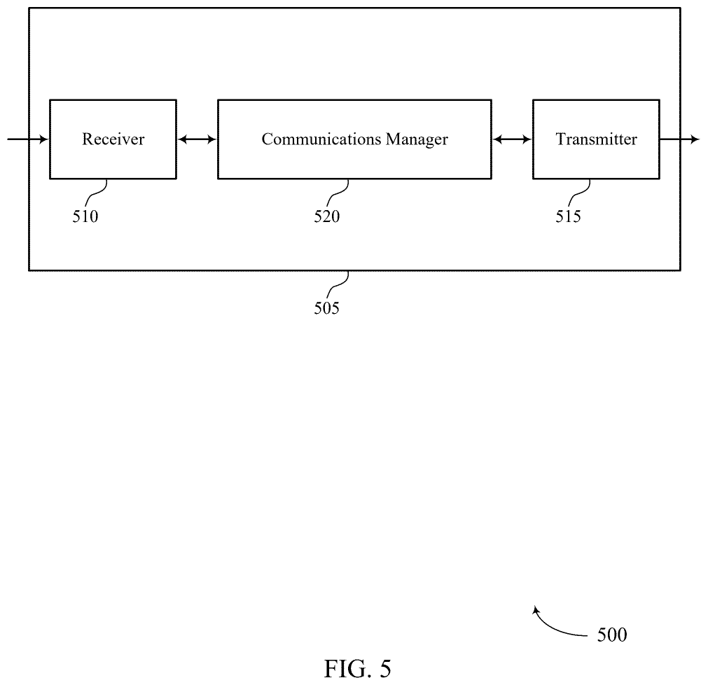

FIG. 5 shows a block diagram 500 of a device 505 that supports transmission power control techniques for scheduling requests in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to transmission power control techniques for scheduling requests). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to transmission power control techniques for scheduling requests). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of transmission power control techniques for scheduling requests as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving a control message including a TPC command for one or more uplink transmissions. The communications manager 520 is capable of, configured to, or operable to support a means for starting a TPC timer in response to receiving the TPC command. The communications manager 520 is capable of, configured to, or operable to support a means for transmitting one or more scheduling requests via a PUCCH, where an uplink transmission power for the one or more scheduling requests is based on whether the TPC timer has expired.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing and more efficient utilization of communication resources.

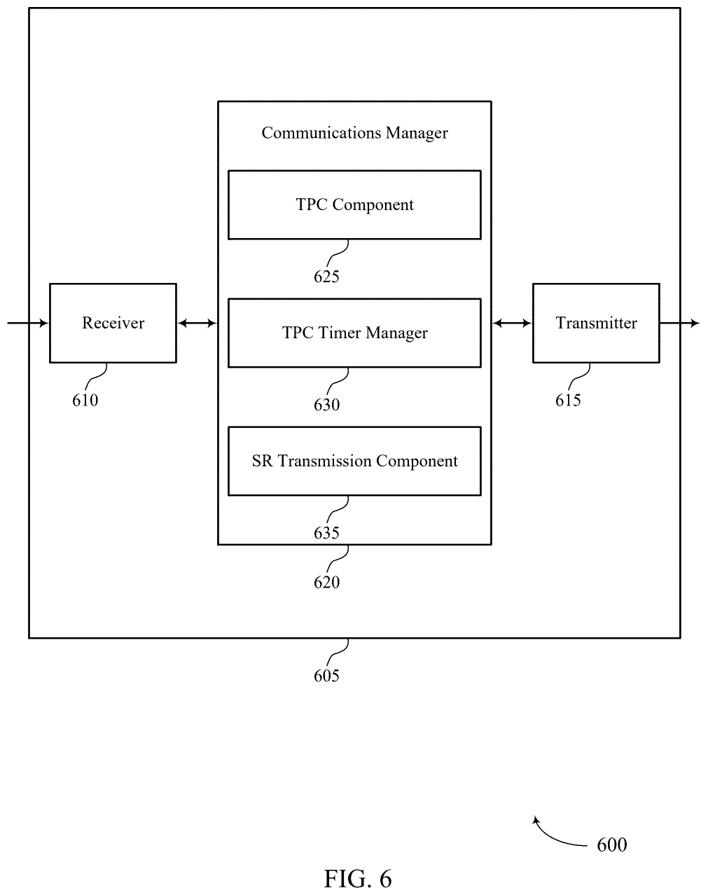

FIG. 6 shows a block diagram 600 of a device 605 that supports transmission power control techniques for scheduling requests in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to transmission power control techniques for scheduling requests). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to transmission power control techniques for scheduling requests). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of transmission power control techniques for scheduling requests as described herein. For example, the communications manager 620 may include a TPC component 625, a TPC timer manager 630, an SR transmission component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The TPC component 625 is capable of, configured to, or operable to support a means for receiving a control message including a TPC command for one or more uplink transmissions. The TPC timer manager 630 is capable of, configured to, or operable to support a means for starting a TPC timer in response to receiving the TPC command. The SR transmission component 635 is capable of, configured to, or operable to support a means for transmitting one or more scheduling requests via a PUCCH, where an uplink transmission power for the one or more scheduling requests is based on whether the TPC timer has expired.

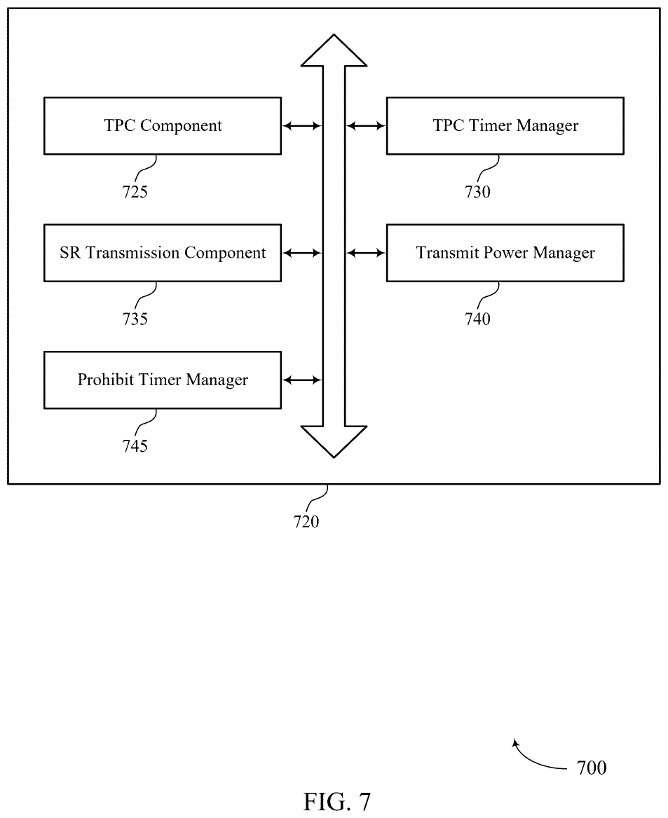

FIG. 7 shows a block diagram 700 of a communications manager 720 that supports transmission power control techniques for scheduling requests in accordance with one or more aspects of the present disclosure. The communications manager 720 may be an example of aspects of a communications manager 520, a communications manager 620, or both, as described herein. The communications manager 720, or various components thereof, may be an example of means for performing various aspects of transmission power control techniques for scheduling requests as described herein. For example, the communications manager 720 may include a TPC component 725, a TPC timer manager 730, an SR transmission component 735, a transmit power manager 740, a prohibit timer manager 745, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The TPC component 725 is capable of, configured to, or operable to support a means for receiving a control message including a TPC command for one or more uplink transmissions. The TPC timer manager 730 is capable of, configured to, or operable to support a means for starting a TPC timer in response to receiving the TPC command. The SR transmission component 735 is capable of, configured to, or operable to support a means for transmitting one or more scheduling requests via a PUCCH, where an uplink transmission power for the one or more scheduling requests is based on whether the TPC timer has expired.

In some examples, the one or more scheduling requests are transmitted prior to an expiration of the TPC timer, and the transmit power manager 740 is capable of, configured to, or operable to support a means for calculating the uplink transmission power for the one or more scheduling requests based on the TPC timer running, where the calculated uplink transmission power is based on a power control parameter, a bandwidth of the PUCCH, a path loss estimate, a PUCCH offset parameter, a PUCCH power adjustment parameter, a power control adjustment state indicated by the TPC command, a threshold transmit power, or any combination thereof.

In some examples, the one or more scheduling requests are transmitted after an expiration of the TPC timer, and the transmit power manager 740 is capable of, configured to, or operable to support a means for determining a first uplink transmission power for a first scheduling request of the one or more scheduling requests based on the expiration of the TPC timer, where the first scheduling request is transmitted using the first uplink transmission power.

In some examples, the SR transmission component 735 is capable of, configured to, or operable to support a means for transmitting, based on the first scheduling request being unsuccessful, a second scheduling request of the one or more scheduling requests after transmitting the first scheduling request, where the second scheduling request is transmitted using a second uplink transmission power that is greater than the first uplink transmission power by a power offset value.

In some examples, the transmit power manager 740 is capable of, configured to, or operable to support a means for receiving a message indicating a set of power offset values, where the power offset value is from the set of power offset values. In some examples, each power offset value of the set of power offset values corresponds to a respective trigger type associated with the one or more scheduling requests.

In some examples, the transmit power manager 740 is capable of, configured to, or operable to support a means for incrementing the power offset value for respective scheduling requests of the one or more scheduling requests that are transmitted after the second scheduling request, where the power offset value is incremented until the uplink transmission power satisfies a threshold uplink transmission power or until a second uplink power control command is received.

In some examples, the transmit power manager 740 is capable of, configured to, or operable to support a means for receiving a second control message including an indication of a set of uplink transmission powers that includes at least the first uplink transmission power, where determining the first uplink transmission power is based on receiving the second control message. In some examples, each uplink transmission power of the set of uplink transmission powers corresponds to respective trigger type for transmitting the one or more scheduling requests.

In some examples, the transmit power manager 740 is capable of, configured to, or operable to support a means for receiving a third control message including an indication of a range of uplink transmission powers that includes at least the first uplink transmission power. In some examples, the transmit power manager 740 is capable of, configured to, or operable to support a means for selecting the first uplink transmission power from the range of uplink transmission powers based on one or more transmission power parameters associated with prior transmissions, where the first uplink transmission power is determined in accordance with the selection. In some examples, the one or more transmission power parameters include one or more uplink transmission powers associated with successful scheduling requests, one or more path loss measurements associated with the successful scheduling requests, or any combination thereof.

In some examples, the transmit power manager 740 is capable of, configured to, or operable to support a means for selecting the first uplink transmission power based on an output of one or more machine learning models, where the one or more machine learning models use a set of parameters associated with a set of prior transmissions.

In some examples, to support transmitting the one or more scheduling requests, the SR transmission component 735 is capable of, configured to, or operable to support a means for transmitting a group of consecutive scheduling requests in accordance with a set of transmission occasions. In some examples, to support transmitting the one or more scheduling requests, the prohibit timer manager 745 is capable of, configured to, or operable to support a means for starting a prohibit timer after transmitting the group of consecutive scheduling requests.

In some examples, the SR transmission component 735 is capable of, configured to, or operable to support a means for receiving a fourth control message indicating a quantity of scheduling requests included in the group of consecutive scheduling requests, where transmitting the group of consecutive scheduling requests is based on the fourth control message.

In some examples, the transmit power manager 740 is capable of, configured to, or operable to support a means for applying respective uplink transmission powers to each scheduling request of the group of consecutive scheduling requests based on whether the TPC timer has expired.

In some examples, the transmit power manager 740 is capable of, configured to, or operable to support a means for applying a fourth uplink transmission power for each scheduling request of the group of consecutive scheduling requests, where an additional group of consecutive scheduling requests transmitted after the group of consecutive scheduling requests uses a fifth uplink transmission power that is greater than the fourth uplink transmission power.

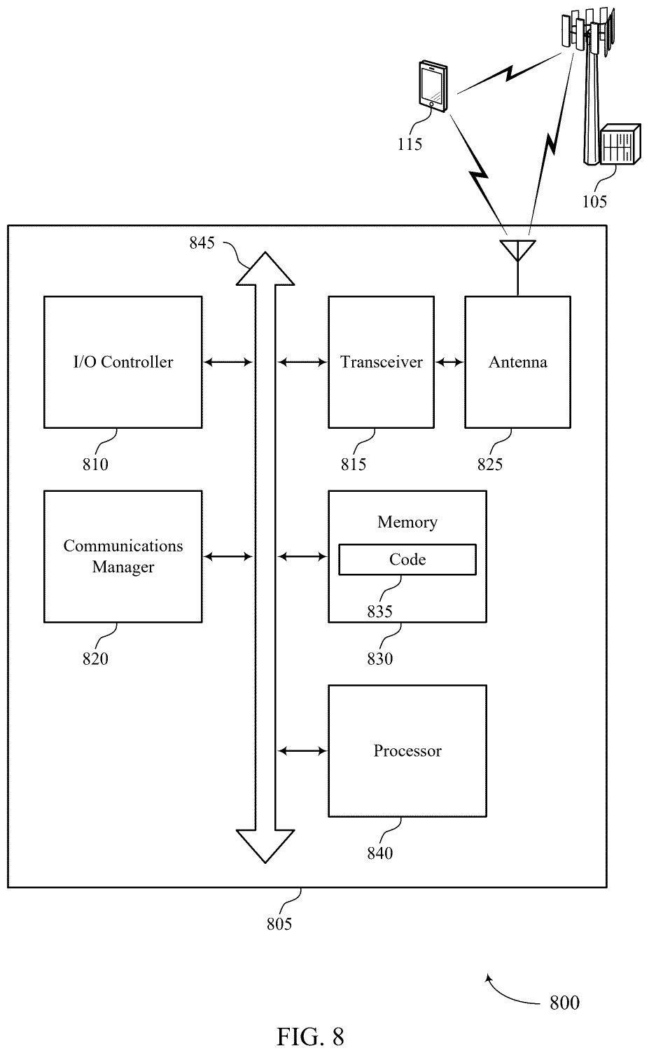

FIG. 8 shows a diagram of a system 800 including a device 805 that supports transmission power control techniques for scheduling requests in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting transmission power control techniques for scheduling requests). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving a control message including a TPC command for one or more uplink transmissions. The communications manager 820 is capable of, configured to, or operable to support a means for starting a TPC timer in response to receiving the TPC command. The communications manager 820 is capable of, configured to, or operable to support a means for transmitting one or more scheduling requests via a PUCCH, where an uplink transmission power for the one or more scheduling requests is based on whether the TPC timer has expired.

By including or configuring the communications manager 820 in accordance with examples as described herein, the device 805 may support techniques for improved communication reliability, reduced latency, improved user experience related to reduced processing, reduced power consumption, more efficient utilization of communication resources, improved coordination between devices, and improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of transmission power control techniques for scheduling requests as described herein, or the at least one processor 840 and the at least one memory 830 may be otherwise configured to, individually or collectively, perform or support such operations.

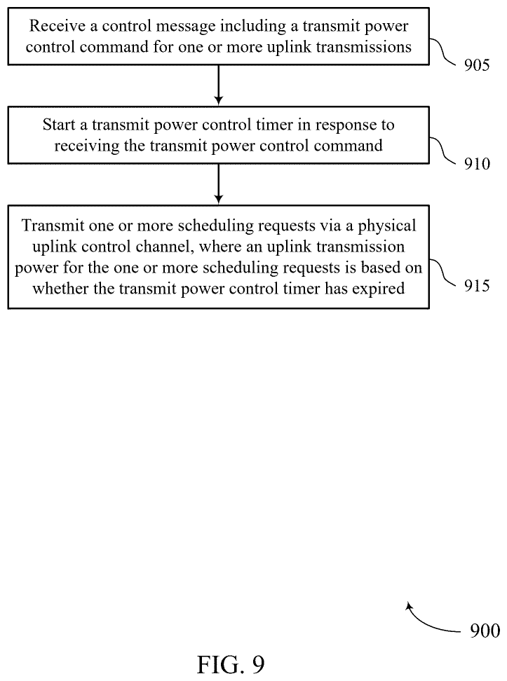

FIG. 9 shows a flowchart illustrating a method 900 that supports transmission power control techniques for scheduling requests in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include receiving a control message including a TPC command for one or more uplink transmissions. The operations of 905 may be performed in accordance with examples as disclosed herein. In some examples, aspects of the operations of 905 may be performed by a TPC component 725 as described with reference to FIG. 7.

At 910, the method may include starting a TPC timer in response to receiving the TPC command. The operations of 910 may be performed in accordance with examples as disclosed herein. In some examples, aspects of the operations of 910 may be performed by a TPC timer manager 730 as described with reference to FIG. 7.

At 915, the method may include transmitting one or more scheduling requests via a PUCCH, where an uplink transmission power for the one or more scheduling requests is based on whether the TPC timer has expired. The operations of 915 may be performed in accordance with examples as disclosed herein. In some examples, aspects of the operations of 915 may be performed by an SR transmission component 735 as described with reference to FIG. 7.

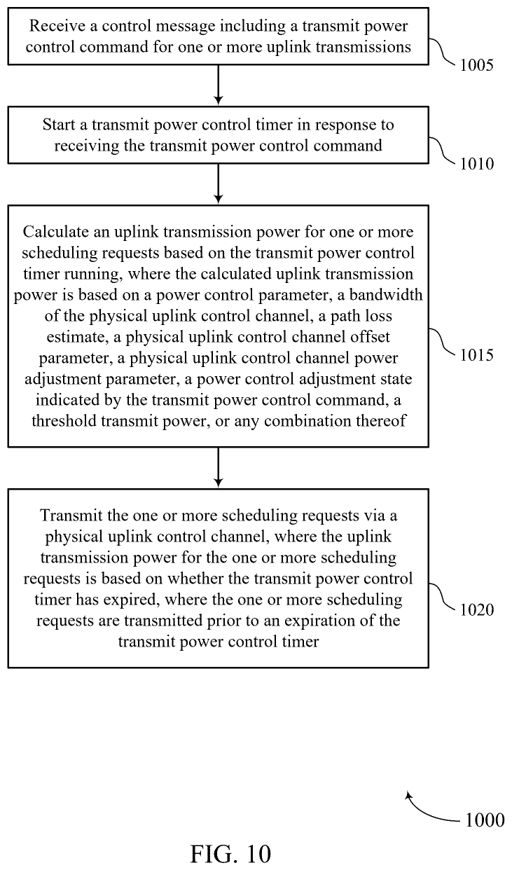

FIG. 10 shows a flowchart illustrating a method 1000 that supports transmission power control techniques for scheduling requests in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include receiving a control message including a TPC command for one or more uplink transmissions. The operations of 1005 may be performed in accordance with examples as disclosed herein. In some examples, aspects of the operations of 1005 may be performed by a TPC component 725 as described with reference to FIG. 7.

At 1010, the method may include starting a TPC timer in response to receiving the TPC command. The operations of 1010 may be performed in accordance with examples as disclosed herein. In some examples, aspects of the operations of 1010 may be performed by a TPC timer manager 730 as described with reference to FIG. 7.

At 1015, the method may include calculating an uplink transmission power for one or more scheduling requests based on the TPC timer running, where the calculated uplink transmission power is based on a power control parameter, a bandwidth of the PUCCH, a path loss estimate, a PUCCH offset parameter, a PUCCH power adjustment parameter, a power control adjustment state indicated by the TPC command, a threshold transmit power, or any combination thereof. The operations of 1015 may be performed in accordance with examples as disclosed herein. In some examples, aspects of the operations of 1015 may be performed by a transmit power manager 740 as described with reference to FIG. 7.

At 1020, the method may include transmitting the one or more scheduling requests via a PUCCH, where the uplink transmission power for the one or more scheduling requests is based on whether the TPC timer has expired, where the one or more scheduling requests are transmitted prior to an expiration of the TPC timer. The operations of 1020 may be performed in accordance with examples as disclosed herein. In some examples, aspects of the operations of 1020 may be performed by an SR transmission component 735 as described with reference to FIG. 7.

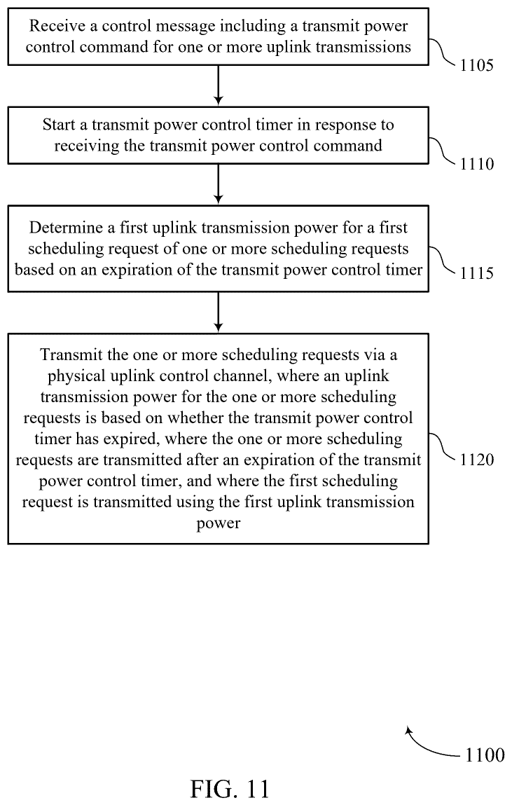

FIG. 11 shows a flowchart illustrating a method 1100 that supports transmission power control techniques for scheduling requests in accordance with one or more aspects of the present disclosure. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1105, the method may include receiving a control message including a TPC command for one or more uplink transmissions. The operations of 1105 may be performed in accordance with examples as disclosed herein. In some examples, aspects of the operations of 1105 may be performed by a TPC component 725 as described with reference to FIG. 7.

At 1110, the method may include starting a TPC timer in response to receiving the TPC command. The operations of 1110 may be performed in accordance with examples as disclosed herein. In some examples, aspects of the operations of 1110 may be performed by a TPC timer manager 730 as described with reference to FIG. 7.

At 1115, the method may include determining a first uplink transmission power for a first scheduling request of one or more scheduling requests based on an expiration of the TPC timer. The operations of 1115 may be performed in accordance with examples as disclosed herein. In some examples, aspects of the operations of 1115 may be performed by a transmit power manager 740 as described with reference to FIG. 7.

At 1120, the method may include transmitting the one or more scheduling requests via a PUCCH, where an uplink transmission power for the one or more scheduling requests is based on whether the TPC timer has expired, where the one or more scheduling requests are transmitted after an expiration of the TPC timer, and where the first scheduling request is transmitted using the first uplink transmission power. The operations of 1120 may be performed in accordance with examples as disclosed herein. In some examples, aspects of the operations of 1120 may be performed by an SR transmission component 735 as described with reference to FIG. 7.

The following provides an overview of aspects of the present disclosure:

Aspect 1: A method for wireless communications, comprising: receiving a control message comprising a transmit power control command for one or more uplink transmissions; starting a transmit power control timer in response to receiving the transmit power control command; and transmitting one or more scheduling requests via a physical uplink control channel, wherein an uplink transmission power for the one or more scheduling requests is based at least in part on whether the transmit power control timer has expired.

Aspect 2: The method of aspect 1, wherein the one or more scheduling requests are transmitted prior to an expiration of the transmit power control timer, the method further comprising: calculating the uplink transmission power for the one or more scheduling requests based at least in part on the transmit power control timer running, wherein the calculated uplink transmission power is based at least in part on a power control parameter, a bandwidth of the physical uplink control channel, a path loss estimate, a physical uplink control channel offset parameter, a physical uplink control channel power adjustment parameter, a power control adjustment state indicated by the transmit power control command, a threshold transmit power, or any combination thereof.

Aspect 3: The method of aspect 1, wherein the one or more scheduling requests are transmitted after an expiration of the transmit power control timer, the method further comprising: determining a first uplink transmission power for a first scheduling request of the one or more scheduling requests based at least in part on the expiration of the transmit power control timer, wherein the first scheduling request is transmitted using the first uplink transmission power.

Aspect 4: The method of aspect 3, further comprising: transmitting, based at least in part on the first scheduling request being unsuccessful, a second scheduling request of the one or more scheduling requests after transmitting the first scheduling request, wherein the second scheduling request is transmitted using a second uplink transmission power that is greater than the first uplink transmission power by a power offset value.

Aspect 5: The method of aspect 4, further comprising: receiving a message indicating a set of power offset values, wherein the power offset value is from the set of power offset values.

Aspect 6: The method of aspect 5, wherein each power offset value of the set of power offset values corresponds to a respective trigger type associated with the one or more scheduling requests.

Aspect 7: The method of any of aspects 4 through 6, further comprising: incrementing the power offset value for respective scheduling requests of the one or more scheduling requests that are transmitted after the second scheduling request, wherein the power offset value is incremented until the uplink transmission power satisfies a threshold uplink transmission power or until a second uplink power control command is received.

Aspect 8: The method of any of aspects 3 through 7, further comprising: receiving a second control message comprising an indication of a set of uplink transmission powers that includes at least the first uplink transmission power, wherein determining the first uplink transmission power is based at least in part on receiving the second control message.

Aspect 9: The method of aspect 8, wherein each uplink transmission power of the set of uplink transmission powers corresponds to respective trigger type for transmitting the one or more scheduling requests.

Aspect 10: The method of any of aspects 3 through 9, further comprising: receiving a third control message comprising an indication of a range of uplink transmission powers that includes at least the first uplink transmission power; and selecting the first uplink transmission power from the range of uplink transmission powers based at least in part on one or more transmission power parameters associated with prior transmissions, wherein the first uplink transmission power is determined in accordance with the selection.

Aspect 11: The method of aspect 10, wherein the one or more transmission power parameters comprise one or more uplink transmission powers associated with successful scheduling requests, one or more path loss measurements associated with the successful scheduling requests, or any combination thereof.

Aspect 12: The method of any of aspects 3 through 11, further comprising: selecting the first uplink transmission power based at least in part on an output of one or more machine learning models, wherein the one or more machine learning models use a set of parameters associated with a set of prior transmissions.

Aspect 13: The method of any of aspects 1 through 12, wherein transmitting the one or more scheduling requests comprises: transmitting a group of consecutive scheduling requests in accordance with a set of transmission occasions; and starting a prohibit timer after transmitting the group of consecutive scheduling requests.

Aspect 14: The method of aspect 13, further comprising: receiving a fourth control message indicating a quantity of scheduling requests included in the group of consecutive scheduling requests, wherein transmitting the group of consecutive scheduling requests is based at least in part on the fourth control message.

Aspect 15: The method of any of aspects 13 through 14, further comprising: applying respective uplink transmission powers to each scheduling request of the group of consecutive scheduling requests based at least in part on whether the transmit power control timer has expired.

Aspect 16: The method of any of aspects 13 through 15, further comprising: applying a fourth uplink transmission power for each scheduling request of the group of consecutive scheduling requests, wherein an additional group of consecutive scheduling requests transmitted after the group of consecutive scheduling requests uses a fifth uplink transmission power that is greater than the fourth uplink transmission power.

Aspect 17: An apparatus for wireless communications, comprising one or more memories storing processor-executable code, and one or more processors coupled with the one or more memories and individually or collectively operable to execute the code to cause the apparatus to perform a method of any of aspects 1 through 16.

Aspect 18: An apparatus for wireless communications, comprising at least one means for performing a method of any of aspects 1 through 16.

Aspect 19: A non-transitory computer-readable medium storing code for wireless communications, the code comprising instructions executable by one or more processors to perform a method of any of aspects 1 through 16.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
one or more memories storing processor-executable code; and
one or more processors coupled with the one or more memories and individually or collectively operable to execute the code to cause the apparatus to:
receive a control message comprising a transmit power control command for one or more uplink transmissions;
start a transmit power control timer in response to receiving the transmit power control command; and
transmit one or more scheduling requests via a physical uplink control channel, wherein an uplink transmission power for the one or more scheduling requests is based at least in part on whether the transmit power control timer has expired.

2. The apparatus of claim 1, wherein the one or more scheduling requests are transmitted prior to an expiration of the transmit power control timer, and the one or more processors are individually or collectively further operable to execute the code to cause the apparatus to:
calculate the uplink transmission power for the one or more scheduling requests based at least in part on the transmit power control timer running, wherein the calculated uplink transmission power is based at least in part on a power control parameter, a bandwidth of the physical uplink control channel, a path loss estimate, a physical uplink control channel offset parameter, a physical uplink control channel power adjustment parameter, a power control adjustment state indicated by the transmit power control command, a threshold transmit power, or any combination thereof.

3. The apparatus of claim 1, wherein the one or more scheduling requests are transmitted after an expiration of the transmit power control timer, and the one or more processors are individually or collectively further operable to execute the code to cause the apparatus to:
determine a first uplink transmission power for a first scheduling request of the one or more scheduling requests based at least in part on the expiration of the transmit power control timer, wherein the first scheduling request is transmitted using the first uplink transmission power.

4. The apparatus of claim 3, wherein the one or more processors are individually or collectively further operable to execute the code to cause the apparatus to:
transmit, based at least in part on the first scheduling request being unsuccessful, a second scheduling request of the one or more scheduling requests after transmitting the first scheduling request, wherein the second scheduling request is transmitted using a second uplink transmission power that is greater than the first uplink transmission power by a power offset value.

5. The apparatus of claim 4, wherein the one or more processors are individually or collectively further operable to execute the code to cause the apparatus to:
receive a message indicating a set of power offset values, wherein the power offset value is from the set of power offset values.

6. The apparatus of claim 5, wherein each power offset value of the set of power offset values corresponds to a respective trigger type associated with the one or more scheduling requests.

7. The apparatus of claim 4, wherein the one or more processors are individually or collectively further operable to execute the code to cause the apparatus to:
increment the power offset value for respective scheduling requests of the one or more scheduling requests that are transmitted after the second scheduling request, wherein the power offset value is incremented until the uplink transmission power satisfies a threshold uplink transmission power or until a second uplink power control command is received.

8. The apparatus of claim 3, wherein the one or more processors are individually or collectively further operable to execute the code to cause the apparatus to:
receive a second control message comprising an indication of a set of uplink transmission powers that includes at least the first uplink transmission power, wherein determining the first uplink transmission power is based at least in part on receiving the second control message.

9. The apparatus of claim 8, wherein each uplink transmission power of the set of uplink transmission powers corresponds to respective trigger type for transmitting the one or more scheduling requests.

10. The apparatus of claim 3, wherein the one or more processors are individually or collectively further operable to execute the code to cause the apparatus to:
receive a third control message comprising an indication of a range of uplink transmission powers that includes at least the first uplink transmission power; and
select the first uplink transmission power from the range of uplink transmission powers based at least in part on one or more transmission power parameters associated with prior transmissions, wherein the first uplink transmission power is determined in accordance with the selection.

11. The apparatus of claim 10, wherein the one or more transmission power parameters comprise one or more uplink transmission powers associated with successful scheduling requests, one or more path loss measurements associated with the successful scheduling requests, or any combination thereof.

12. The apparatus of claim 3, wherein the one or more processors are individually or collectively further operable to execute the code to cause the apparatus to:
select the first uplink transmission power based at least in part on an output of one or more machine learning models, wherein the one or more machine learning models use a set of parameters associated with a set of prior transmissions.

13. The apparatus of claim 1, wherein, to transmit the one or more scheduling requests, the one or more processors are individually or collectively operable to execute the code to cause the apparatus to:
transmit a group of consecutive scheduling requests in accordance with a set of transmission occasions; and
start a prohibit timer after transmitting the group of consecutive scheduling requests.

14. The apparatus of claim 13, wherein the one or more processors are individually or collectively further operable to execute the code to cause the apparatus to:
receive a fourth control message indicating a quantity of scheduling requests included in the group of consecutive scheduling requests, wherein transmitting the group of consecutive scheduling requests is based at least in part on the fourth control message.

15. The apparatus of claim 13, wherein the one or more processors are individually or collectively further operable to execute the code to cause the apparatus to:
apply respective uplink transmission powers to each scheduling request of the group of consecutive scheduling requests based at least in part on whether the transmit power control timer has expired.

16. The apparatus of claim 13, wherein the one or more processors are individually or collectively further operable to execute the code to cause the apparatus to:
apply a fourth uplink transmission power for each scheduling request of the group of consecutive scheduling requests, wherein an additional group of consecutive scheduling requests transmitted after the group of consecutive scheduling requests uses a fifth uplink transmission power that is greater than the fourth uplink transmission power.

17. A method for wireless communications, comprising:
receiving a control message comprising a transmit power control command for one or more uplink transmissions;
starting a transmit power control timer in response to receiving the transmit power control command; and
transmitting one or more scheduling requests via a physical uplink control channel, wherein an uplink transmission power for the one or more scheduling requests is based at least in part on whether the transmit power control timer has expired.

18. The method of claim 17, wherein the one or more scheduling requests are transmitted prior to an expiration of the transmit power control timer, the method further comprising:
calculating the uplink transmission power for the one or more scheduling requests based at least in part on the transmit power control timer running, wherein the calculated uplink transmission power is based at least in part on a power control parameter, a bandwidth of the physical uplink control channel, a path loss estimate, a physical uplink control channel offset parameter, a physical uplink control channel power adjustment parameter, a power control adjustment state indicated by the transmit power control command, a threshold transmit power, or any combination thereof.

19. The method of claim 17, wherein the one or more scheduling requests are transmitted after an expiration of the transmit power control timer, the method further comprising:
determining a first uplink transmission power for a first scheduling request of the one or more scheduling requests based at least in part on the expiration of the transmit power control timer, wherein the first scheduling request is transmitted using the first uplink transmission power.

20. An apparatus for wireless communications, comprising:
means for receiving a control message comprising a transmit power control command for one or more uplink transmissions;
means for starting a transmit power control timer in response to receiving the transmit power control command; and
means for transmitting one or more scheduling requests via a physical uplink control channel, wherein an uplink transmission power for the one or more scheduling requests is based at least in part on whether the transmit power control timer has expired.
